(19) United States
(12) Patent Application Publication
(10) Pub. No.: US 2024/0315895 A1
(43) Pub. Date: Sep. 26, 2024

(54) VEHICLE INTELLIGENT LIFTING SYSTEM

(71) Applicant: CHUNGAN TECHNOLOGY CO., LTD., Tainan City (TW)

(72) Inventor: Chung-I Fang, Tainan City (TW)

(21) Appl. No.: 18/680,324

(22) Filed: May 31, 2024

Related U.S. Application Data
(63) Continuation-in-part of application No. 17/245,129, filed on Apr. 30, 2021.

(51) Int. Cl. A61G 3/06; H04L 67/12; H04W 4/48

(52) U.S. Cl. CPC A61G 3/062; H04L 67/12; H04W 4/48

(57) ABSTRACT

A vehicle intelligent lifting system, configured to be mounted to a vehicle body including an in-vehicle control unit, is provided, including: a control module, in communication with the in-vehicle control unit, configured to obtain a signal from the in-vehicle control unit; a lifting device, in communication with the control module; wherein the control module determines whether to control the lifting device to operate according to vehicle information from the in-vehicle control unit.

The present invention is a CIP of application Ser. No. 17/245,129, filed Apr. 30, 2021, the entire contents of which are hereby incorporated by reference.

### BACKGROUND OF THE INVENTION

### Field of the Invention

### Description of the Prior Art

In few decades, human's life time is getting longer and longer, so the number of people who need long-term care is considerably increasing. The government and private facilities are also actively developing a perfect long-term care system and equipment in order to cope with this situation. The welfare vehicle is equipped with lifting equipment in the carriage to facilitate the transportation of wheelchair users who need long-term care.

However, the lifting equipment of the conventional welfare vehicle has the following shortcomings. In order to save time, the operator often does not turn off the welfare vehicle, pull the handbrake and carry out other safety measures when operating the lifting equipment, so the welfare vehicle will accidentally move and cause danger. Furthermore, when other vehicles are approaching, it can cause big risks to the operator in operating the lifting equipment. Therefore, these shortcomings have to be improved urgently.

The present invention is, therefore, arisen to obviate or at least mitigate the above-mentioned disadvantages.

### SUMMARY OF THE INVENTION

The main object of the present invention is to provide a vehicle intelligent lifting system which can improve the safety for operation.

To achieve the above and other objects, a vehicle intelligent lifting system, configured to be mounted to a vehicle body including a Controller Area Network (CAN) bus, is provided, including: a control module, in communication with the CAN bus, configured to obtain a signal from the CAN bus; a lifting device, in communication with the control module; wherein the control module determines whether to control the lifting device to operate according to vehicle information from the CAN bus.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is schematic view of a preferable embodiment of the present invention;

FIG. 2 is a partial stereogram of a preferable embodiment of the present invention;

FIG. 3 is a block diagram of a preferable embodiment of the present invention;

FIG. 4 is a schematic view of another preferable embodiment of the present invention; and

FIG. 5 is a flow chart showing operation of a vehicle intelligent lifting system of a preferable embodiment of the present invention.

### DETAILED DESCRIPTION OF THE PREFERRED EMBODIMENTS

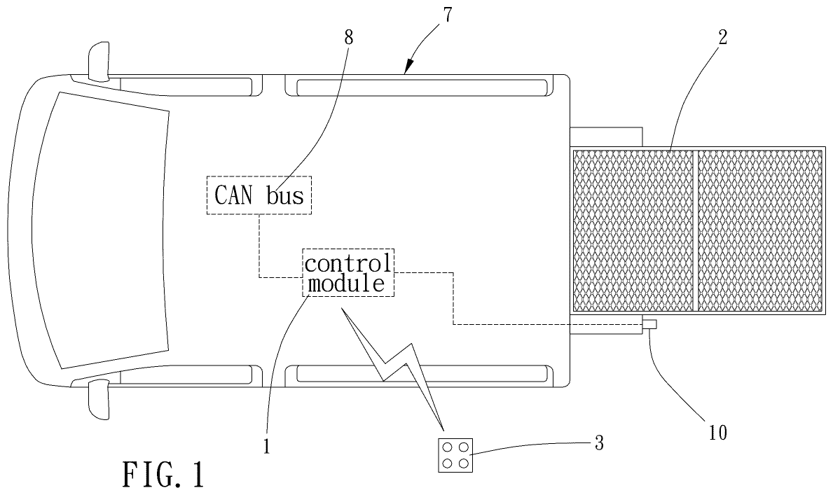

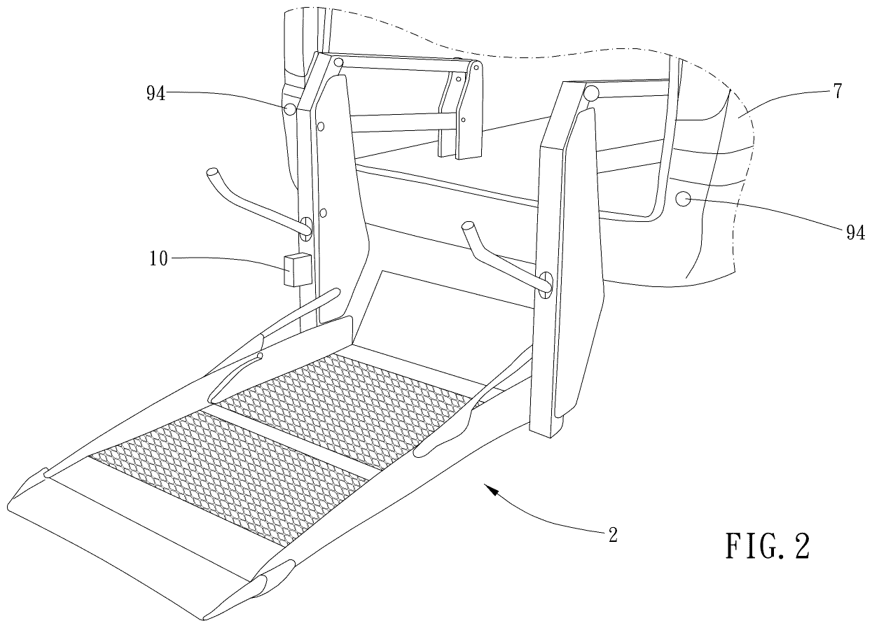

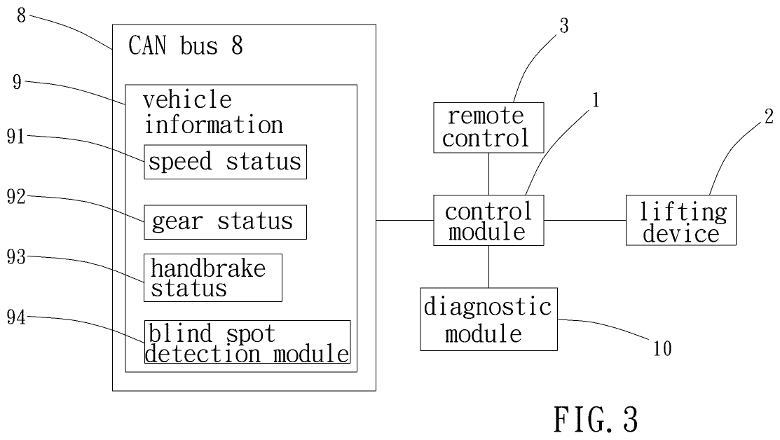

Please refer to FIGS. 1 to 3 for a preferable embodiment of the present invention. A vehicle intelligent lifting system of the present invention is configured to be mounted to a vehicle body 7 including an in-vehicle control unit. In this embodiment, the in-vehicle control unit is a Controller Area Network (CAN) bus 8; however, the in-vehicle control unit may be a Local Interconnect Network (LIN), FlexRay communication system or Keyword Protocol 2000 (KWP2000) module. The vehicle intelligent lifting system includes a control module 1 and a lifting device 2.

The control module 1 is in communication with the CAN bus 8 and configured to obtain a signal from the CAN bus 8.

The lifting device 2 is in communication with the control module 1.

The control module 1 determines whether to control the lifting device 2 to operate according to vehicle information 9 from the CAN bus 8. Whereby, the control module 1 can determine whether it is the right time to operate the lifting device 2 according to the vehicle information 9 from the CAN bus 8, which ensures safety operation of the lifting device 2.

The vehicle information 9 may include at least one of speed status 91, gear status 92 and handbrake status 93. In this embodiment, the vehicle information 9 includes speed status 91, gear status 92 and handbrake status 93, and the control module 1 does not turn on the power of the lifting device 2 until the speed status is 0 km/h, the gear status is under a parking mode and the handbrake is applied; otherwise, the power of the lifting device 2 is not turned on. This can avoid damager due to unintentional operation of the lifting device 2 as the vehicle is moving.

Preferably, the vehicle intelligent lifting system further includes a remote control 3, the remote control 3 is in communication with the control module 1, and the remote control 3 is configured to input a control signal to the control module 1 for controlling the lifting device 2. Preferably, the remote control 3 is in communication with the control module 1 by Bluetooth, and there needs no one to stand near the vehicle body 7, which is highly safe and avoids damage to wires of the wired controller.

The CAN bus 8 may be in communication with a blind spot detection module 94. When the blind spot detection module 94 detects a vehicle near the vehicle body 7, the CAN bus 8 transmits an associated signal to the control module 1, and the control module 1 turns off the power of the lifting device 2, for avoiding risks during operating the lifting device 2 as there is the vehicle near the vehicle body 7.

In this embodiment, the control module 1 is connected with an on-board diagnostic (OBD-II) interface connected with the CAN bus 8 so that control module 1 can be in communication with the CAN bus 8 well. In other embodiment, the control module 1 may be in communication with the CAN bus 8, which avoids damage to wires for transmitting signals.

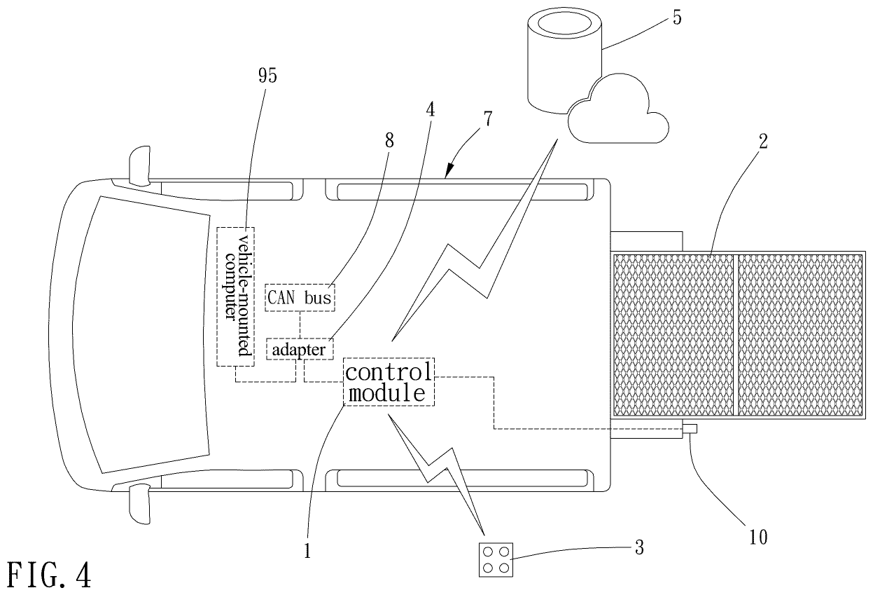

Please refer to FIG. 4, in an alternative embodiment, the vehicle intelligent lifting system further includes an adapter 4, the adapter 4 is connected with an on-board diagnostic interface connected with the CAN bus 8, the control module 1 is connected with the adapter 4, and the adapter 4 is configured to be connected with a vehicle-mounted computer 95 mounted to the vehicle body 7.

The adapter 4 is configured to connect both the control module 1 and the vehicle-mounted computer 95 to the CAN bus 8, which allows the vehicle-mounted computer 95 to be additionally mounted to the vehicle body 7 easily.

The vehicle intelligent lifting system may further include a cloud processing center 5, the cloud processing center 5 is in communication with the control module 1 via an internet, and the control module 1 transmits the vehicle information 9 to the cloud processing center 5. The vehicle information 9 may include information of at least one of battery capacity, fuel capacity and mileage of the vehicle body 7 so that the cloud processing center 5 can immediately obtain circumstances or states of the vehicle body 7. The cloud processing center 5 may be in communication with an advanced driver assistance systems (ADAS) mounted on the vehicle body 7, for security monitoring.

The vehicle intelligent lifting system is in communication with the CAN bus, and the external information of the vehicle can be transmitted and stored into the computer on the vehicle. Specifically, The lifting device 2 includes a diagnostic module 10, the diagnostic module 10 is configured to obtain status diagnostic data (such as diagnostic code(s)) of the lifting device 2. The status diagnostic data may represent malfunction, disorder or the like of any part of the lifting device 2, or/and represent any obstacles or/and damages to any part of the lifting device 2. The diagnostic module 10 is, for example, via an on-board diagnostic (OBD-II) interface, in communication with the control module 1, for transmitting the status diagnostic data of the lifting device 2 to the control module 1. As such, at least one of the vehicle information 9 and the status diagnostic data of the lifting device 2 can be transmitted to and saved in the in-vehicle control unit, and the at least one of the vehicle information 9 and the status diagnostic data of the lifting device 2 can be transmitted to and in communication with at least one of external devices (such as other vehicle(s), portable electric device(s), computer(s), server(s) or the like), so that the at least one of the vehicle information 9 and the status diagnostic data of the lifting device 2 can be broadly applied.

The control module 1 determines whether to control the lifting device 2 to operate according to the vehicle information 9 and the status diagnostic data of the lifting device 2. In order to improve the maintainability of the lifting device 2, the diagnostic module 10 can be designed to generate the status diagnostic data which is capable of being integrated to the in-vehicle control unit of a vehicle via an on-board diagnostic (OBD-II) interface, so that a diagnosis on the lifting device 2 can be carried out by the in-vehicle control unit of the vehicle, which facilitates repair and integration. In addition, the in-vehicle control unit of the vehicle can also obtain the status diagnostic data of the lifting device 2 and control the lifting device 2 according the vehicle information 9 and the status diagnostic data of the lifting device 2. For example, the user needs to shut down the vehicle and apply the handbrake before using the the lifting device 2, and the vehicle information 9 (such as GPS data, mileage, engine data, gear status, and handbrake status, etc.) and the status diagnostic data of the lifting device 2 can be uploaded to the cloud processing center 5 via the Internet of Things (such as 4G, NB-IOT, LORA, bluetooth, sixfox, etc.), and this allows the monitoring on the vehicle and the lifting device 2 on the basis of the the vehicle information 9 and the status diagnostic data of the lifting device 2 from the cloud processing center 5, so that the vehicle can be mastered at any time, and so that a plurality of vehicles can be managed through another control unit in communication with the cloud processing center 5.

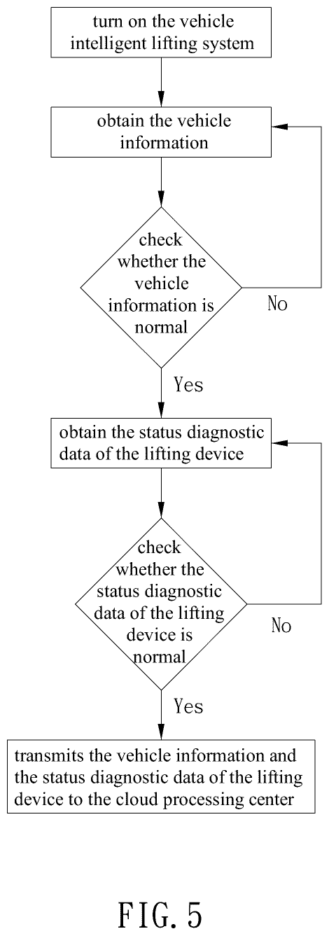

As shown in FIG. 5, in operation, the vehicle intelligent lifting system is turned on; the in-vehicle computer and the in-vehicle control unit check whether the vehicle information 9 is normal, if yes, check whether the status diagnostic data of the lifting device from the diagnostic module 10 is normal, otherwise check whether the vehicle information 9 is normal against; if the in-vehicle computer and the in-vehicle control unit check the status diagnostic data of the lifting device from the diagnostic module 10 is normal, the control module transmits the vehicle information 9 and the status diagnostic data of the lifting device to the cloud processing center 5 via an internet, otherwise check whether the status diagnostic data of the lifting device from the diagnostic module 10 is normal against.

It improves judgment in driving information and achieves vehicle-to-everything (V2X) vehicle-to-vehicle (V2V) or the like. This allows vehicles to transmit wireless signals and communicate with each other (in V2V) or with any objects (in V2X), which effectively reduces risks of collision or loss of control, improves controllability and stability of the vehicle, ensures the safety of the cargo, personnel, battery on the vehicle, and lowers risk of traffic accidents and impact magnitude in traffic accidents.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A vehicle intelligent lifting system, configured to be mounted to a vehicle body, the vehicle body including an in-vehicle control unit, the in-vehicle control unit being a Controller Area Network (CAN) bus, a Local Interconnect Network (LIN), a FlexRay communication system or a Keyword Protocol 2000 (KWP2000) module, the vehicle intelligent lifting system including:
a control module, in communication with the in-vehicle control unit, configured to obtain a signal from the in-vehicle control unit;
a lifting device, in communication with the control module; and
a cloud processing center, in communication with the control module via an internet;
wherein the lifting device includes a diagnostic module, the diagnostic module is configured to obtain status diagnostic data of the lifting device, the diagnostic module is in communication with the control module and capable of transmitting the status diagnostic data of the lifting device to the control module, the control module is configured to transmit the status diagnostic data of the lifting device to the in-vehicle control unit of the vehicle so that the diagnostic module can be designed to generate the status diagnostic data which is capable of being integrated to the in-vehicle control unit of the vehicle, and the control module is configured to transmit the vehicle information and the status diagnostic data of the lifting device to the cloud processing center so that it allows the monitoring on the vehicle and the lifting device on the basis of the the vehicle information and the status diagnostic data of the lifting device from the cloud processing center;
wherein the control module determines whether to control the lifting device to operate according to the vehicle information and the status diagnostic data of the lifting device.

2. The vehicle intelligent lifting system of claim 1, wherein the vehicle information from the in-vehicle control unit includes at least one of speed status, gear status and handbrake status.

3. The vehicle intelligent lifting system of claim 2, wherein the control module does not turn on the power of the lifting device until the speed status is 0 km/h, the gear status is under a parking mode and the handbrake is applied.

4. The vehicle intelligent lifting system of claim 1, further including a remote control, wherein the remote control is in communication with the control module, and the remote control is configured to input a control signal to the control module for controlling the lifting device.

5. The vehicle intelligent lifting system of claim 4, wherein the remote control is in communication with the control module by Bluetooth.

6. The vehicle intelligent lifting system of claim 1, wherein the in-vehicle control unit is in communication with a blind spot detection module, and when the blind spot detection module detects a vehicle near the vehicle body, the in-vehicle control unit transmits an associated signal to the control module, and the control module turns off the power of the lifting device.

7. The vehicle intelligent lifting system of claim 1, wherein the status diagnostic data represents malfunction or/and disorder of any part of the lifting device, or/and represents any obstacles or/and damages to any part of the lifting device.

8. The vehicle intelligent lifting system of claim 1, wherein the control module is connected with an on-board diagnostic (OBD-II) interface connected with the in-vehicle control unit.

9. The vehicle intelligent lifting system of claim 1, wherein the control module is in communication with the in-vehicle control unit by Bluetooth.

10. The vehicle intelligent lifting system of claim 1, further including an adapter, wherein the adapter is connected with an on-board diagnostic (OBD-II) interface connected with the in-vehicle control unit, the control module is connected with the adapter, and the adapter is configured to be connected with a vehicle-mounted computer mounted to the vehicle body.
